(19) United States
(12) Patent Application Publication
(10) Pub. No.: US 2021/0237102 A1
(43) Pub. Date: Aug. 5, 2021

(54) SPRAY HEAD

(71) Applicant: Kohler Mira Limited, Gloucestershire (GB)

(72) Inventors: Simon Westgate, Cheltenham (GB); Adam May, Cheltenham (GB); Robin Whitfield, Cheltenham (GB)

(73) Assignee: Kohler Mira Limited, Gloucestershire (GB)

(21) Appl. No.: 17/228,305

(22) Filed: Apr. 12, 2021

Related U.S. Application Data
(63) Continuation of application No. PCT/GB2019/052179, filed on Aug. 2, 2019.

(30) Foreign Application Priority Data
Oct. 31, 2018 (GB) 1817779.0

(51) Int. Cl. B05B 1/18; B05B 1/12

(52) U.S. Cl. CPC B05B 1/185; B05B 1/12

(57) ABSTRACT

A spray head for an ablutionary appliance such as a shower includes a body with a fluid inlet, a spray plate with a plurality of holes, and nozzles of flexible material. Each nozzle has an inlet end for fluid and a discharge end adapted to project through a corresponding hole for discharge of the fluid, and a control member, movement of which is adapted to adjust the angle of the discharge end of at least one nozzle relative to the spray plate and the inlet end of the nozzle, between two end positions.

### CROSS-REFERENCE TO RELATED PATENT APPLICATIONS

The present application is a Continuation of International Patent Application No. PCT/GB2019/052179, filed Aug. 2, 2019, which claims priority to United Kingdom Priority Application GB 1817779.0, filed Oct. 31, 2018, the entire disclosures of both of which are incorporated by reference herein.

### BACKGROUND

This invention relates to a spray head for an ablutionary appliance or fitting, and in particular a spray head adapted to provide multiple spray patterns.

The invention has particular application for shower heads but need not be limited to this use, as it may also be used for taps or hoses. It will however be described with reference only to shower heads.

Users often require different spray characteristics for showers. Known spray heads may have two or more modes, each providing a different spray characteristic, such as a gentle spray or an invigorating spray. The user chooses one of these for their shower, and may even wish to change mode during the shower. It is therefore important that it is easy to switch from one mode to another. Typically, a shower head with more than one mode has sets of nozzles, which may be provided in a flexible nozzle mat; switching between modes being provided by switching between different water channels in the spray head, which results in the use of different sets of nozzles for discharging the water. There is usually a limited number of modes, which may not correspond to the user's requirements.

It would be advantageous to provide a spray head that addresses these and other issues associated with known spray heads.

### SUMMARY

According to an exemplary embodiment, a spray head for an ablutionary appliance includes a body with a fluid inlet, a spray plate with a plurality of holes, and nozzles of flexible material. Each nozzle has an inlet end for fluid and a discharge end adapted to project through a corresponding hole for discharge of the fluid, and a control member, movement of which is adapted to adjust the angle of the discharge end of at least one nozzle relative to the spray plate and the inlet end of the nozzle, between two end positions.

### BRIEF DESCRIPTION OF THE DRAWINGS

Embodiments of the invention are illustrated, by way of example only, in the accompanying drawings in which:

FIG. 1 is a perspective view of a spray head;

FIG. 2 is a section through a first embodiment of spray head in a first spray pattern;

FIG. 3 is similar to FIG. 2, but shows a second spray pattern;

FIG. 4 is a section through a second embodiment of a spray head;

FIG. 5 is a perspective view of a component of FIG. 4; and

FIG. 6 is a part-section similar to FIG. 4, showing different spray patterns.

### DETAILED DESCRIPTION

According to the present invention, a spray head for an ablutionary appliance comprises a body with a fluid inlet, a spray plate with a plurality of holes, and nozzles of flexible material, each nozzle having an inlet end for fluid and a discharge end adapted to project through a corresponding hole for discharge of the fluid, and a control member, movement of which is adapted to adjust the angle of the discharge end of at least one nozzle relative to the spray plate and the inlet end of the nozzle, between two end positions.

Adjusting the angle of the discharge end of the nozzles relative to the spray plate provides a way of varying the spray pattern continuously between the end positions. This enables the user to choose a preferred spray pattern before or during a shower. Providing the adjustment by moving the discharge end of a flexible nozzle relative to the inlet end ensures a simple construction.

Conveniently, movement of the control member is achieved by circumferential movement of a member on the outside of the body. The control member may be moved directly by the user. Alternatively, a separate operating member moved by the user may act on the control member.

In one embodiment the holes in the spray plate are shaped to guide the nozzle ends to determine the spray pattern. Movement of the control member moves at least one nozzle in the corresponding hole to adjust the angle of the discharge end. The control member may move the nozzles sequentially, or all the nozzles simultaneously.

The control member is conveniently accommodated in the body, and moves linearly in response to operation of a separate operating member. Where the operating member moves circumferentially, the spray head includes means to translate the rotational movement to linear movement of the control member. The translation means may comprise a screw thread mechanism, or a cam arrangement. The operating member conveniently comprises a plate mounted on a spindle in the body, and having a projection outside the body. The user can grasp or press the projection to rotate the plate.

The nozzles may be mounted in the control member as individual components. The movement of the control member then acts directly to move the discharge ends in the holes in the spray plate. Alternatively, the nozzles may be provided on a flexible mat, and the control member acts on the flexible mat to move it linearly towards and away from the spray plate, thus moving the nozzle ends in the holes. The control member is then connected to the flexible mat in any convenient way.

In another embodiment the control member is adapted to contact at least one nozzle at an intermediate point in its length. Movement of the control member applies a lateral force to each nozzle to adjust the angle of the discharge end.

Conveniently the control member comprises an apertured plate mounted rotatably in the body, with a peripheral edge outside the body. The user grasps the peripheral edge in order to move the plate circumferentially. The plate is provided with circumferentially-extending cam surfaces within the body to act on the nozzles. The arrangement is such that the discharge ends move radially relative to the spray plate. One set of cam surfaces is provided at the outer edge of the plate, to act on the radially outermost nozzles. The plate may have radially-extending spokes, with further cam surfaces supported between adjacent spokes to act on radially inner nozzles.

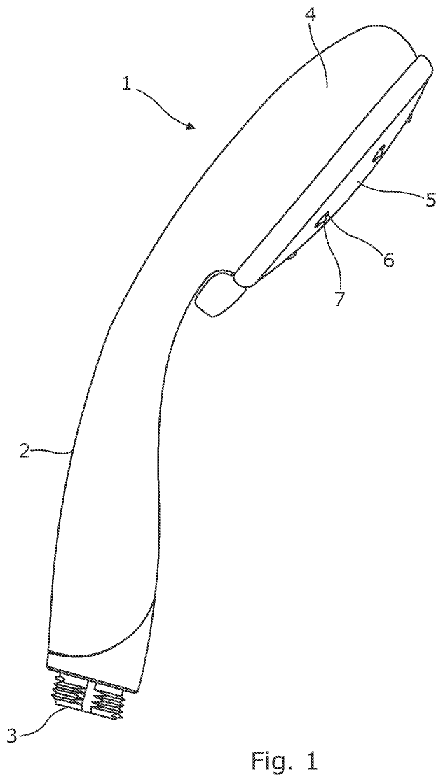

FIG. 1 shows a spray head 1 for a shower. The spray head 1 comprises a body 2 with a water inlet 3 leading to a spray chamber 4 and a spray plate 5 with holes 6. Each hole 6 has a corresponding nozzle 7 of flexible material, for discharge of water in a spray pattern. A control member (not shown in FIG. 1) is provided for continuously varying the spray pattern by changing the angle of the nozzles 7 relative to the spray plate 5 between two end positions. In one of the end positions the spray pattern has a relatively large area of coverage, and in the other end position the spray pattern has a much smaller area of coverage.

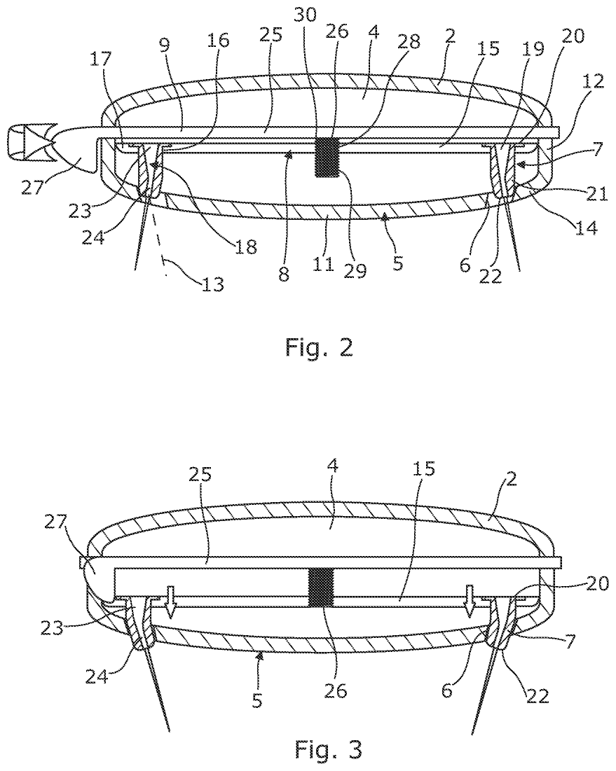

FIGS. 2 and 3 show sections through the spray head 1, in the two end positions. Each shows the body 2, the chamber 4, the spray plate 5 with holes 6, nozzles 7, the control member 8 and an operating member 9 for the control member 8.

The spray plate 5 is of circular outline and is attached to the body 2 in any suitable way. It comprises an outer part 11 of part-spherical outline, and a cylindrical part 12 by which it is attached to the body 2. The holes 6 have a substantially frusto-conical profile, with an axis 13 angled towards the center of the spray plate 5. It will be appreciated that only the holes 6 at the peripheral edge 14 of the spray plate 5 are shown. Holes 6 nearer the center of the spray plate 5 may have their axis angled less, and those at or very near the center of the spray plate may have an axis perpendicular to the spray plate 5.

The control member 8 comprises a control plate 15 with stepped apertures 16, each aperture 16 corresponding to a hole 6 in the spray plate 5. The outer peripheral edge 17 of the control plate 15 is guided for movement in the cylindrical part 12 of the spray plate 5. The control plate 15 is shown as a planar member, but it may be of stepped outline corresponding to the curved outline of the outer part 11 of the spray plate 5. Each aperture 16 receives an individual nozzle 7, which also projects into the corresponding hole 6 in the spray plate 5.

Each nozzle 7 is of flexible material, such as rubber or a rubber-like plastics material, so that it is also resilient. Each nozzle 7 is of circular outline in plan view, although it may have a different outline. Each nozzle 7 has a profiled internal fluid passage 18. Externally the nozzle 7 has an inlet end 19 with an out-turned flange 20, and a main part 21 of frusto-conical outline, terminating in a discharge end 22. The flange 20 is received in an aperture 16, and the discharge end 22 projects into a hole 6 in the spray plate 5. The internal fluid passage 18 has a substantially conical passage 23 at the inlet end 19, open to the chamber 4, and leading to a cylindrical passage 24 terminating at the discharge end 22. The direction of fluid discharge is also shown in the Figures.

The operating member 9 controls movement of the control member 8 between the end positions shown in FIGS. 2 and 3. The movement of the control member 8 is linear and continuous. The operating member 9 comprises a plate 25 rigidly connected to a spindle 26 at the center of the spray plate 5. The plate 25 is sealingly received in a circumferential slot between the spray plate 5 and the body 2, and is able to move circumferentially, being rotatable about the axis of the spindle 26. The plate 25 has a radial projection 27 extending outside the body 2 for grasping or pressing by the user to move the plate 25 circumferentially relative to the spray plate 5 and the body 2.

The spindle 26 is rigidly connected at one end 28 to the center of the plate 25 so that movement of the plate 25 rotates the spindle 26, but they cannot move relatively axially. The spindle 26 is provided with an external screw-thread 29 which is received in an internally threaded aperture 30 provided at the center of the control plate 15. Movement of the plate 25 in one direction moves the control plate 15 on the spindle 26 towards the spray plate 5. Movement of the plate 25 in the other direction moves the control plate 15 on the spindle 26 away from the spray plate 5. The amount of circumferential movement of the plate 25 is chosen according to the pitch of the screw thread, to ensure that the control plate 15 can move between the two end positions of FIGS. 2 and 3. If a fast thread is used the circumferential movement may be limited to 90°, but it may be up to or more than 360° as required.

As the control plate 15 moves towards the spray plate 5 the discharge ends 22 of the nozzles 7 are moved outwardly in the holes 6, and are guided by the profiles of the holes 6, so that for each nozzle the discharge end 22 moves relative to the inlet end 19 and the spray plate 5, thus moving the angle of discharge radially towards the center of the spray plate 5. As the control plate 15 moves away from the spray plate 5 the discharge ends 22 move inwardly in the holes 6, moving the angle of discharge away from the center of the spray plate 5.

Thus, in use, the water flows from the inlet 3 into the spray chamber 4 of the body 2, and then through the nozzles 7 and the spray plate holes 6. The user can choose the required spray pattern by moving the plate 25 to move the control plate 15 between the end positions. In the end position shown in FIG. 2 the nozzle ends 22 are accommodated in the holes 6, and the angle of the ends 22 is such that they create a spray pattern of relatively large area. As the plate 25 is moved towards the position of FIG. 3, the control plate 15 is moved towards the spray plate 5, causing the discharge ends 22 of the nozzles 7 also to move towards the spray plate 5, such that the nozzle ends 22 are guided by the holes 6 to change the angle of the ends, and move the direction of discharge radially towards the center of the spray plate 5. This causes the area of the spray pattern to reduce, until it is at a minimum when the plate 25 reaches the other end position of FIG. 3. Moving the plate 25 back towards the position shown in FIG. 2 causes the control plate 15 to move away from the spray plate 5, also moving the discharge ends of the nozzles 7 away from the spray plate 5 and changing the direction of discharge to increase the area of the spray pattern. It will be appreciated that the spray pattern is varied continuously between the two end positions.

In a modification (not shown) the nozzles 7 may be formed as part of a circular mat, attached to the control member 8 in any suitable way. In a further modification (not shown) such a mat may also be constructed to include the control member. The mechanism translating circumferential movement of the plate 25 to linear movement of the spindle 26 and control member 8 may also be of any appropriate type. In modifications (not shown) the control member 8 may be operated in any other suitable way, for example by an operating member 9 that also moves linearly.

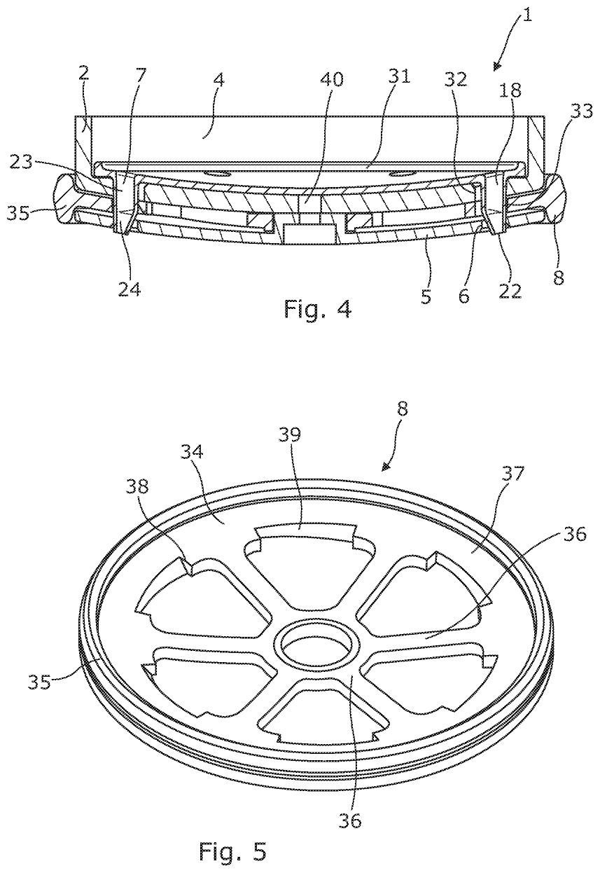

FIGS. 4 to 6 show a further embodiment of the spray head 1, and corresponding reference numerals have been applied to corresponding parts.

As in the embodiment of FIGS. 1 to 3, in the embodiment of FIGS. 4 to 6 the spray head 1 has a body 2 with a chamber 4 connected to the water inlet (not shown), a spray plate 5, nozzles 7 and a control member 8.

The spray plate 5 is a curved disc, with holes 6 (only those round the periphery are shown), and a central boss 40 projecting internally. The boss 40 has a central aperture (not shown) enabling it to be attached to the body 2. The boss 40 also mounts the control member 8, which is accommodated between the spray plate 5 and the body 2.

The nozzles 7 are formed as part of a mat 31 of flexible material, which is accommodated in the chamber 4 and provides a seal for the chamber 4. The material of the mat 31 is also resilient. The body 2 and the control member 8 have apertures 32, 33 respectively, the arrangement being such that each hole 6 in the spray plate 5 has a corresponding aperture 32 in the body 2 and a corresponding aperture 33 in the control member 8, through which a nozzle 7 projects. Each nozzle 7 is of substantially the same form as the nozzles 7 of FIGS. 2 and 3, having a substantially frusto-conical external profile with the discharge end angled slightly away from the center of the mat 31, and an internal fluid passage 18 with a substantially conical inner end 23 and a cylindrical part 24 terminating at the discharge end 22.

The control member 8 is shown in FIG. 5, and comprises a wheel-like component 34 having a curved profile to match that of the body 2 and the spray plate 5. An outer enlarged rim 35 of the component 34 is outside the body 2, and can be grasped by the user to move the control member 8 circumferentially relative to the spray plate 5 and the body 2. The control member 8 has a central ring 36 journalled on the central boss 40 of the spray plate 5, to allow the rotational movement. Radial spokes 37 connect the central ring 36 to an outer ring 37 on which the enlarged rim 35 is formed.

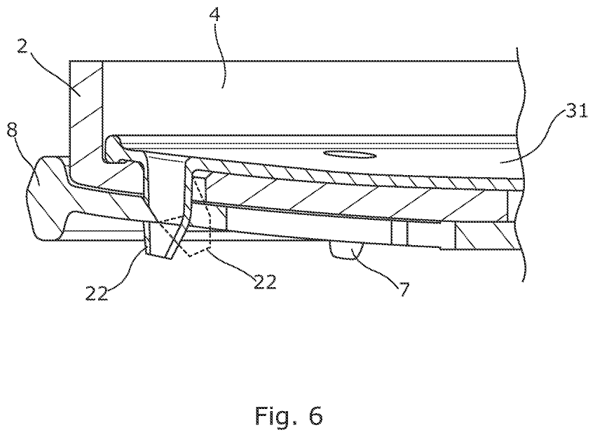

The radially inner face 38 of the outer ring 37 is formed with cam surfaces 39 corresponding to the nozzles 7 at the outer periphery of the mat 31. Each cam surface 39 curves radially inwardly, and contacts the corresponding nozzle 7 at an intermediate point in its length. In one end position of the cam surface 39 relative to the nozzle 7 there is a slight contact between the cam surface and the nozzle, and as the control member 8 moves circumferentially the cam surface 39 applies a force to the nozzle 7 to move the discharge end 22 radially inwardly relative to the inlet end 19 and the spray plate 5, thus changing the angle of the discharge end 22, and the direction of discharge of the water. FIG. 6 (in which the spray plate 5 is not shown) shows the two end positions of the direction of discharge, with the dashed lines showing the position of a nozzle 7 in the end position where the spray pattern has a minimum area.

For use, as with the first embodiment, the water flows from the inlet 3 into the spray chamber 4 of the body 2, and through the nozzles 7 and holes 6 in the spray plate 5. The user can choose the required spray pattern by rotating the control member 8 between the two end positions defined by the circumferential movement of the cam surfaces 39 relative to the corresponding nozzles 7. As the control member 8 moves from one end position, of slight contact between the cam surfaces 35 and the nozzles 7 to the other end, the cam surfaces 39 move the nozzle ends 22 radially inwardly. Because the nozzles 7 are resilient as well as flexible, they will follow the cam surfaces 39 as the control member 8 moves in the opposite direction.

In a modification (not shown) further cam surfaces may be provided between adjacent radial spokes to act on radially inner nozzles.

It will be appreciated that in each embodiment the spray pattern is changed without affecting the fluid flow and pressure through the internal passage 18.

What is claimed is:

1. A spray head for an ablutionary appliance comprises a body with a fluid inlet, a spray plate with a plurality of holes, and nozzles of flexible material, each nozzle having an inlet end for fluid and a discharge end adapted to project through a corresponding hole for discharge of the fluid, and a control member, movement of which is adapted to adjust the angle of the discharge end of at least one nozzle relative to the spray plate and the inlet end of the nozzle, between two end positions.

2. The spray head of claim 1, wherein the spray head is configured such that by circumferential movement of a member on the outside of the body causes movement of the control member.

3. The spray head of claim 1, wherein the control member is configured to be moved directly by the user.

4. The spray head of claim 1, wherein a separate operating member moved by the user acts on the control member.

5. The spray head of claim 1, wherein the holes in the spray plate are shaped to guide the nozzle ends to determine the spray pattern.

6. The spray head of claim 5, wherein the spray head is configured such that movement of the control member moves at least one nozzle in the corresponding hole to adjust the angle of the discharge end.

7. The spray head of claim 6, wherein the control member is configured to move the nozzles sequentially, or all the nozzles simultaneously.

8. The spray head of claim 6, wherein the control member is configured to move all the nozzles simultaneously.

9. The spray head of claim 1, wherein the control member is accommodated in the body, and is configured to move linearly in response to operation of a separate operating member.

10. The spray head of claim 9, wherein the operating member is configured to move circumferentially, and the spray head includes means to translate the rotational movement to linear movement of the control member.

11. The spray head of claim 10, wherein the translation means comprises a screw thread mechanism, or a cam arrangement.

12. The spray head of claim 9, wherein the operating member comprises a plate mounted on a spindle in the body, and having a projection outside the body.

13. The spray head of claim 1, wherein the nozzles are mounted in the control member as individual components and the movement of the control member acts directly to move the discharge ends in the holes in the spray plate.

14. The spray head of claim 1, wherein the nozzles are provided on a flexible mat, and the control member acts on the flexible mat to move it linearly towards and away from the spray plate, thus moving the nozzle ends in the holes.

15. The spray head of claim 1, wherein the control member is adapted to contact at least one nozzle at an intermediate point in its length, and movement of the control member applies a lateral force to each nozzle to adjust the angle of the discharge end.

16. The spray head of claim 15, wherein the control member comprises an apertured plate mounted rotatably in the body, with a peripheral edge outside the body, and is configured to allow a user to grasp the peripheral edge in order to move the plate circumferentially.

17. The spray head of claim 16, wherein the plate is provided with circumferentially-extending cam surfaces within the body to act on the nozzles and the discharge ends move radially relative to the spray plate.

18. The spray head of claim 17, wherein one set of cam surfaces is provided at the outer edge of the plate, to act on the radially outermost nozzles.

19. The spray head of claim 18, wherein the plate has radially-extending spokes, with cam surfaces supported between adjacent spokes to act on radially inner nozzles.
